(19) United States
(12) Patent Application Publication
(10) Pub. No.: US 2024/0113650 A1
(43) Pub. Date: Apr. 4, 2024

(54) TEMPERATURE PROTECTION DEVICE AND CONTROL DEVICE

(71) Applicant: FANUC CORPORATION, Yamanashi (JP)

(72) Inventor: Jun FUJIMOTO, Yamanashi-ken (JP)

(21) Appl. No.: 18/262,583

(22) PCT Filed: Jan. 20, 2022
(86) PCT No.: PCT/JP2022/002000

§ 371 Date: Jul. 24, 2023

(30) Foreign Application Priority Data
Feb. 1, 2021 (JP) 2021-014546

(51) Int. Cl. H02P 29/68

(52) U.S. Cl. CPC H02P 29/68

(57) ABSTRACT

A temperature protection device includes: a storage unit for storing a temperature protection line defined on the basis of a time during which a current is continuously supplied from an electric motor driver device to an electric motor and the allowable temperatures of the electric motor and electric motor driver device; a temperature computing unit for computing the temperature of the electric motor or electric motor driver device by obtaining the current value of the current supplied from the electric motor driver device to the electric motor; and a determination unit for determining whether the temperature exceeds a temperature protection line.

### TECHNICAL FIELD

The present invention relates to a temperature protection device and a control device configured to protect from temperature an electric motor and an electric motor driving device that drives an electric motor.

### BACKGROUND ART

JP 2002-354886 A discloses a technology for an electric power tool in order to protect an electric motor. Such an electric power tool detects a generated amount of heat generated from the electric motor. The electric power tool suspends the transmission of electrical power from the electric motor to an output shaft, in the case that the detected generated amount of heat lies outside of a certain range.

### SUMMARY OF THE INVENTION

With the technology disclosed in JP 2002-354886 A, although it is possible to protect the electric motor, it is difficult to reliably protect a driving device that drives the electric motor. For example, the driving device may be damaged due to the generation of heat of the driving device itself. However, the technology disclosed in JP 2002-354886 A does not take into consideration how to contend with such a situation.

The present invention has the object of providing a temperature protection device and a control device that are capable of protecting an electric motor and an electric motor driving device from temperature.

A temperature protection device according to one aspect comprises a storage unit which, in order to protect from temperature an electric motor and an electric motor driving device, is configured to drive the electric motor, is configured to store a temperature protection line defined on the basis of a time period during which electrical current is continuously supplied to the electric motor from the electric motor driving device, and an allowable temperature of the electric motor and the electric motor driving device, an electrical current acquisition unit configured to acquire an electrical current value of the electrical current supplied to the electric motor from the electric motor driving device, a temperature calculation unit configured to calculate a temperature of the electric motor or the electric motor driving device based on the electrical current value that was acquired, a determination unit configured to determine whether or not the temperature has exceeded the temperature protection line, and a notification unit which, in the case that the determination unit has determined that the temperature has exceeded the temperature protection line, is configured to issue a notification to that effect.

According to the present invention, the temperature protection device and the control device are provided that are capable of protecting the electric motor and the electric motor driving device from temperature.

### BRIEF DESCRIPTION OF DRAWINGS

FIG. 1 is a diagram showing an electric motor control system according to an embodiment of the present invention;

FIG. 2 is a diagram illustrating an example of a thermal model;

FIG. 3 is a diagram showing an example of a temperature protection line;

FIG. 4 is a diagram showing an example of a time-wise change in an electrical current;

FIG. 5 is a diagram showing an example of a temperature protection line;

FIG. 6 is a diagram showing another Example 1 of a time-wise change in an electrical current;

FIG. 7 is a diagram showing another Example 2 of a time-wise change in an electrical current; and

FIG. 8 is a diagram showing an example of an operation procedure of the electric motor control system according to the embodiment.

### DETAILED DESCRIPTION OF THE INVENTION

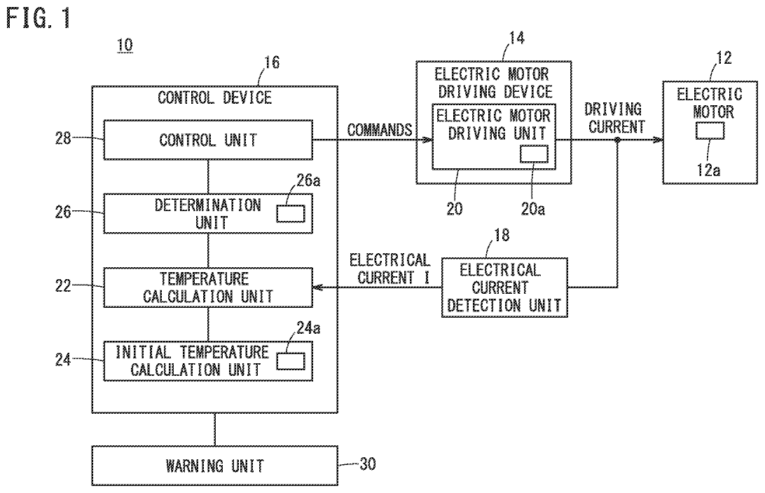

FIG. 1 is a diagram showing an electric motor control system 10 according to an embodiment of the present invention. As shown in FIG. 1, the electric motor control system 10 according to the present embodiment includes an electric motor 12, an electric motor driving device 14, and a control device 16.

The electric motor 12, for example, includes a stator, a rotor, and a bearing. Coils are wound around the stator. The rotor rotates with respect to the stator. The bearing retains the rotor so as to be capable of rotating. By the coils of the stator being electrically energized by a driving current from the electric motor driving device 14, magnetic fields are generated from the coils. Due to the magnetic fields, the rotor is made to rotate (operation of the electric motor 12). The electric motor 12 includes a heat generating unit 12a that generates heat at a time when the operation thereof is carried out. As the heat generating unit 12a, the coils of the stator may be cited. The electric motor 12 or the electric motor driving device 14 includes an electrical current detection unit 18 that detects a magnitude of the driving current. The electrical current detection unit 18 outputs the magnitude of the detected driving current as an electrical current value I to the control device 16.

The electric motor driving device 14 includes, for example, an electric motor driving unit 20 including a switching element. The electric motor driving unit 20 converts an electrical current from an electrical power source (not shown), and supplies the electrical current to the electric motor 12 as a driving current (operation of the electric motor driving device 14). The electric motor driving unit 20 includes a heat generating unit 20a that generates heat at a time when the operation thereof is carried out. As the heat generating unit 20a, a switching element and a resistive element may be cited.

In this manner, each of the electric motor 12 and the electric motor driving device 14, respectively, includes the heat generating unit 12a and the heat generating unit 20a. The heat generating unit 12a and the heat generating unit 20a generate heat during driving of the electric motor 12. In the case that the generated amount of heat generated from the heat generating unit 12a and the heat generating unit 20a (ultimately, the temperature T(t) of the electric motor 12 or the electric motor driving device 14) is excessive, a concern arises in that it may become difficult to appropriately operate the electric motor 12 or the electric motor driving device 14.

The control device 16, by controlling the electric motor driving device 14, serves to drive the electric motor 12. Further, the control device 16 functions as the temperature protection device. Specifically, the control device 16 calculates the temperature T(t), which changes in accordance with a time t, and by monitoring the calculated temperature T(t), serves to protect the electric motor 12 and the electric motor driving device 14 from temperature. The control device 16 includes a temperature calculation unit 22, an initial temperature calculation unit 24, a determination unit 26, and a control unit 28. A warning unit 30 is connected to the control device 16. Accordingly, the control device 16 is substantially further equipped with the warning unit 30. Moreover, it should be noted that the temperature T in this instance implies a temperature with the external environment serving as a reference (namely, a temperature difference from the external environment).

Although the temperature calculation unit 22, the initial temperature calculation unit 24, the determination unit 26, and the control unit 28 can be configured by a combination of hardware (a processor and a memory) and software (a program), the present invention is not necessarily limited to such a combination.

The control unit 28 controls the electric motor driving device 14 by issuing commands to the electric motor driving device 14. Consequently, the electric motor 12 is driven. Further, based on the determination result of the determination unit 26, the control unit 28 controls the warning unit 30 and the electric motor driving device 14. Details concerning this feature will be described later.

The temperature calculation unit 22 acquires the electrical current value I of the driving current detected by the electrical current detection unit 18. On the basis of the acquired electrical current value I, the temperature calculation unit 22 calculates the temperature T(t) of the electric motor 12 or the electric motor driving device 14. More specifically, the temperature calculation unit 22 calculates a generated amount of heat Ph from the electrical current value I. Further, the temperature calculation unit 22 calculates the temperature T(t) of the electric motor 12 or the electric motor driving device 14, based on the generated amount of heat Ph and a time constant τ of the electric motor 12 or the electric motor driving device 14. The time constant τ is determined from a heat capacity Ch and a heat resistance Rh of the electric motor 12 or the electric motor driving device 14. Details concerning the calculation of the temperature T(t) will be described later.

The initial temperature calculation unit 24 includes a storage unit 24a. The storage unit 24a stores the temperature Toff and the time at which the electric motor control system 10 is stopped. The time when the electric motor control system 10 is stopped signifies a point in time at which the electrical power source of the electric motor driving device 14 is turned OFF. The temperature Toff implies a temperature of the electric motor 12 or the electric motor driving device 14 at a point in time when the electrical power source of the electric motor driving device 14 is turned OFF. The temperature Toff is calculated by the temperature calculation unit 22. The initial temperature calculation unit 24 calculates an initial temperature T(0) based on an elapsed time period te, and the temperature Toff. The elapsed time period te signifies a time period that has elapsed from when the power source of the electric motor driving device 14 was turned OFF until the power source is turned ON. The initial temperature T(0) implies a temperature of the electric motor 12 or the electric motor driving device 14 at a point in time when the electrical power source of the electric motor driving device 14 is turned ON. More specifically, the initial temperature calculation unit 24 calculates the initial temperature T(0) based on the elapsed time period te, an off-time temperature Toff, and the time constant τ. Details concerning the calculation of the initial temperature T(0) will be described later.

The determination unit 26 includes a table (a storage unit) 26a that stores a temperature protection line (an allowable temperature Td(t)). The determination unit 26 determines whether or not the temperature T has exceeded the temperature protection line (the allowable temperature Td(t)).

The determination unit 26 monitors the temperature T(t) resulting from the generated heat generated by the (driving) current supplied from the electric motor driving device 14 to the electric motor 12. More specifically, the determination unit 26 determines whether or not the temperature T(t) has exceeded the temperature protection line (the allowable temperature Td(t)). Details concerning the temperature protection line (the allowable temperature Td(t)) will be described later.

On the basis of the determination result of the determination unit 26, the control unit 28 controls the warning unit 30 and the electric motor driving device 14. In the case that the determination unit 26 has determined that the temperature T has exceeded the temperature protection line, the control unit 28 controls the warning unit 30 and the electric motor driving device 14. In this case, by controlling the warning unit 30, the control unit 28 is capable of issuing a notification concerning a warning to the operator. Further, by controlling the electric motor driving device 14, the control unit 28 causes the driving of the electric motor 12 to stop (provides an instruction to stop). More specifically, in the case that the determination unit 26 has determined that the temperature T has exceeded the temperature protection line, the control unit 28 functions as a drive stopping unit that causes the electric motor 12 to stop.

The warning unit 30 is constituted, for example, by a display device (a liquid crystal display or the like), an audio output device (a speaker or the like), or alternatively, both of these devices. The warning unit 30 functions as a notification unit. Specifically, in the case that the determination unit 26 has determined that the temperature T(t) has exceeded the temperature protection line (the allowable temperature Td(t)), the warning unit 30 issues a notification to the operator by way of an image, sound, or both, that the temperature T(t) has exceeded the temperature protection line.

### (Details Concerning Calculation of the Temperature T(t))

The temperature calculation unit 22 calculates the temperature T(t (=n·ts)) using, for example, a thermal model represented by the following Equation (1). As will be described later, Equation (1) can be used to calculate both a temperature T1(t) of the electric motor 12, and a temperature T2(t) of the electric motor driving device 14.

T(n·ts)=K1·T((n−1)·ts)+K2·Ph (1)

T(n·ts): The temperature of the electric motor 12 or the electric motor driving device 14 at an n-th sampling time period ts, wherein the elapsed time period t and the n-th sampling time period ts have the relationship of “t=n·ts”.
K1: coefficient, K1=exp(−ts/τ)
K2: coefficient, K2=Rh·(1−K1)
τ: time constant, τ=Ch·Rh
Ph: generated amount of heat (a heat flow rate generated from a heat source Hs)
Ch: heat capacity
Rh: heat resistance

Moreover, it should be noted that the temperature T(t) is a temperature based on the external environment. Specifically, the temperature T(t) signifies a temperature difference between the electric motor 12 and the external environment, or a temperature difference between the electric motor driving device 14 and the external environment. The heat source Hs in this instance is the heat generating unit 12a or the heat generating unit 20a.

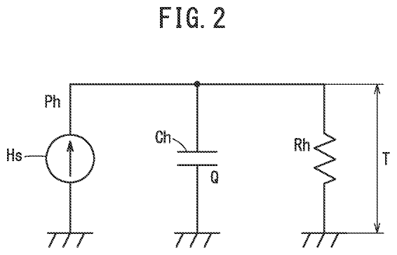

Equation (1) can be derived as follows. FIG. 2 is a diagram illustrating an example of a thermal model. FIG. 2 shows a thermal model of the electric motor 12 (or the electric motor driving device 14) in the form of an equivalent circuit. Such an equivalent circuit represents a target object (the electric motor 12 or the electric motor driving device 14) connected to the heat source Hs (the heat generating unit 12a or the heat generating unit 20a). The thermal property of the target object is represented by a heat resistance Rh and a heat capacity Ch. The target object has a temperature (more precisely, a temperature difference from the external environment) T. A generated amount of heat (a generated heat flow rate) Ph from the heat source Hs flows into the object. The generated amount of heat Ph is accumulated in the target object as an amount of heat Q (=Ch·T). The amount of heat Q accumulated in the target object is radiated through the heat resistance Rh.

In this case, the differential equation shown in the following Equation (2) is satisfied.

dT/dt=−T/(Ch·Rh)+Ph/Ch (2)

The following Equation (3) is obtained by solving the differential equation of Equation (2).

$$\begin{matrix}T ( t ) = exp ( - t / τ ) \cdot T ( 0 ) + Rh \cdot ( 1 - exp ( - t / τ ) ) \cdot Ph \\ = K 1 \cdot T ( 0 ) + Rh \cdot ( 1 - K 1 ) \cdot Ph\end{matrix} \qquad ( 3 )$$

In this instance, the temperature calculation unit 22 calculates the temperature T(t) using a discrete time period in units of the sampling time period ts. When T(0)=T((n−1)·ts), then Equation (1) is derived from Equation (3).

Equation (1), which is derived in the manner described above, represents a relationship between the temperature T((n−1)·ts) at the (n−1)-th sampling time period ts, and the temperature T(n·ts) at the n-th sampling time period ts. At the (n−1)-th sampling time period ts, the time period t (=(n−1)·ts) is exceeded. At the n-th sampling time period ts, the time period t (=n·ts) has elapsed. The initial temperature T(0) is a temperature when the electrical power source of the electric motor driving device 14 is turned ON. Furthermore, by sequentially calculating temperatures T(1·ts), T(2·ts), . . . , T((n−1)·ts) for each of the sampling time periods ts, the temperature T(n·ts) can be calculated. The temperature T(n ts) signifies a temperature T(t) that changes over time.

If the electric motor 12 and the electric motor driving device 14 are sufficiently cooled, the “initial temperature T(0)=0” can be set. More specifically, in the case that a time period has elapsed since the drive was stopped, and there is actually no temperature difference from the external environment, the electric motor 12 and the electric motor driving device 14 are already sufficiently cooled. For example, in the case that the electric motor 12 and the electric motor driving device 14 have not yet sufficiently been cooled, the initial temperature T(0) calculated by the initial temperature calculation unit 24 is used to calculate the temperature T(n·ts).

The temperature T1(t) of the electric motor 12 and the temperature T2(t) of the electric motor driving device 14 are obtained by applying a generated amount of heat Ph1 of the electric motor 12 and a generated amount of heat Ph2 of the electric motor driving device 14 to the generated amount of heat Ph.

As shown in the following equation (4), the generated amount of heat Ph1 of the electric motor 12 per unit time period is calculated from the electrical current value I of the electric motor 12 and the electrical resistance Re of the electric motor 12. The electrical resistance Re of the electric motor 12 basically implies the electrical resistance of the coils.

Ph1=Re·I² (4)

When Equation (4) is substituted into Equation (1), the temperature T1(t (=n·ts)) of the electric motor 12 is expressed by the following Equation (5).

T1(n·ts)=K3·T1((n−1)·ts)+K4·Re·I² (5)
K3: coefficient (K3=exp(−ts/τ1))
K4: coefficient (K4=Rh1·(1−K3))
τ1: time constant of the electric motor 12 (τ1=Ch1·Rh1)
Ch1: heat capacity of the electric motor 12
Rh1: heat resistance of the electric motor 12

The generated amount of heat Ph2 (per unit time period) of the electric motor driving device 14 is calculated from the electrical current value I of the electric motor 12 and a conversion efficiency η and the like.

$$\begin{matrix}Ph 2 = W 0 - W 1 = ( ( 1 - η ) / η ) \cdot W 1 \\ = ( ( 1 - η ) / η ) \cdot E \cdot I \\ = A \cdot {I}^{2}\end{matrix} \qquad ( 6 )$$

E: voltage applied to the electric motor 12
A: coefficient (A=((1−η)/η)·E/I)
η: conversion efficiency (η=W1/W0)
W0: power input to the electric motor driving device 14
W1: electrical power output from the electric motor driving device 14 (input to the electric motor 12) (W1=E·I)

When Equation (6) is substituted into Equation (1), the temperature T2(t) of the electric motor driving device 14 is expressed by the following equation (7).

T2(n·ts)=K5·T2((n−1)·ts)+K6·A·I² (7)
K5: coefficient (K5=exp(−ts/τ2))
K6: coefficient (K6=Rh2·(1−K5))
τ2: time constant of the electric motor driving device 14 (τ2=Ch2·Rh2)
Ch2: heat capacity of the electric motor driving device 14
Rh2: heat resistance of the electric motor driving device 14

Moreover, it should be noted that the coefficients K3 and K4 can be obtained experimentally, for example, in the following manner. At first, the electric motor driving device 14 drives the electric motor 12, and thereby raises the temperature T1(t) of the electric motor 12. After the temperature T1(t) of the electric motor 12 has risen, the electric motor driving device 14 causes the driving of the electric motor 12 to stop. The time constant τ1 is determined on the basis of the change in the temperature T1(t) of the electric motor 12 after the electric motor 12 has been made to stop. Furthermore, the coefficient K3 and the coefficient K4 are calculated from the time constant τ1. The coefficient K5 and the coefficient K6 as well can be determined substantially in the same manner. However, the temperature T2(t), the time constant τ2, the coefficient K5, and the coefficient K6 are used instead of the temperature T1(t), the time constant τ1, the coefficient K3, and the coefficient K4.

The temperature T1(t) of the electric motor 12 and the temperature T2(t) of the electric motor driving device 14 that are expressed by Equation (5) and Equation (7) generally differ from each other. Accordingly, strictly speaking, it is preferable to separately calculate the temperature T1(t) and the temperature T2(t). More specifically, the calculated temperature T1(t) and the calculated temperature T2(t) are compared respectively with separate temperature threshold values Tth1 and Tth2. In this manner, by comparing the temperature T1(t) with the temperature threshold value Tth1, and further, by comparing the temperature T2(t) with the temperature threshold value Tth2, it is possible to protect the electric motor 12 and the electric motor driving device 14.

However, a case will be described herein in which one of the temperature T1(t) and the temperature T2(t) is used in order to protect the electric motor 12 and the electric motor driving device 14. Such processing becomes possible if the time constant τ1 of the electric motor 12 and the time constant τ2 of the electric motor driving device 14 are in close proximity to a certain extent. The time constant τ1 and the time constant τ2 have a relationship, for example, of “0.5<τ1/τ2<2”. More preferably, the time constant τ1 and the time constant τ2 have a relationship of “0.67<τ1/τ2<1.5”.

If the time constant τ1 and the time constant τ2 are equal to each other (τ1=τ2), in Equation (5) and Equation (7), the coefficient K3 becomes equal to the coefficient K5, and the coefficient K4 becomes equal to the coefficient K6 (K3=K5, K4=K6). In this case, the following Equation (8) is derived from Equation (5) and Equation (7). Moreover, it should be noted that the fact that the electrical current value I is common in Equation (5) and Equation (7) also leads to the derivation of Equation (8). Namely, the timing at which heat is generated and heat is radiated from the electric motor 12 and the electric motor driving device 14 is the same, which also leads to Equation (8).

T1(t)/T2(t)=Re/A (8)

Equation (8) implies that the temperature T1(t) of the electric motor 12 and the temperature T2(t) of the electric motor driving device 14 are in a corresponding relationship (specifically, a type of proportional relationship). More specifically, the temperature T1(t) and the temperature T2(t) increase and decrease in a corresponding relationship to each other. Even if the time constant τ1 and the time constant τ2 are not equal to each other, if they are in close proximity to a certain extent, the corresponding relationship (correspondence) between the temperature T1(t) and the temperature T2(t) is maintained. As a result, the overall temperature of the electric motor 12 and the electric motor driving device 14 can be evaluated using the temperature T1(t) or the temperature T2(t). According to the present embodiment, the timing at which heat is generated and heat is radiated in the electric motor 12 and the electric motor driving device 14 is the same. Therefore, if the time constant τ1 and the time constant τ2 are in close proximity to a certain extent, a single equation (a single thermal model) can be used, and thereby both of the devices can be protected from temperature.

### (Details Concerning the Calculation of the Initial Temperature T(0))

The initial temperature calculation unit 24 calculates the initial temperature T(0) using, for example, Equation (5) or Equation (7). More specifically, in Equation (5), the initial temperature calculation unit 24 substitutes the off-time temperature Toff for the temperature T1 ((n−1)·ts). Next, with the electrical current being at I=0, the initial temperature calculation unit 24 calculates the after-m-steps temperature T(m·ts). This temperature T(m·ts) corresponds to the initial temperature T(0). However, m is a value obtained by dividing the elapsed time period te by the sampling time period ts (m=te/ts).

In this instance, the initial temperature calculation unit 24 may calculate the initial temperature T(0) using another method. More specifically, by using the following Equation (9), and without performing a step calculation, the initial temperature calculation unit 24 may calculate the initial temperature T(0) after the elapsed time period te.

T(0)=Toff·exp(−te/τ1) (9)

### (Details Concerning the Temperature Protection Line)

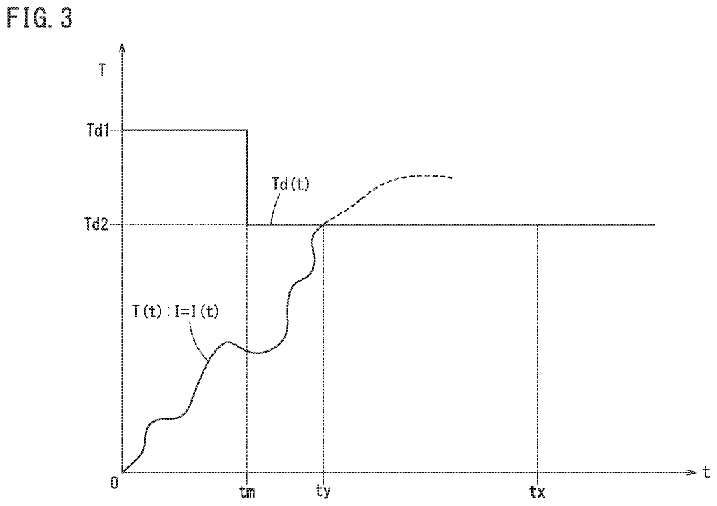

FIG. 3 is a diagram showing an example of the temperature protection line. The temperature protection line (the allowable temperature Td(t)) represents a relationship between a time period t during which electrical current is continuously supplied from the electric motor driving device 14 to the electric motor 12, and the allowable temperature Td(t) of the electric motor 12 and the electric motor driving device 14.

As shown in FIG. 3, the allowable temperature Td(t) changes over time. Herein, as an example, at time tm, the allowable temperature Td(t) is switched from an allowable temperature Td1 to an allowable temperature Td2. More specifically, the allowable temperature Td(t) is equal to the allowable temperature Td1 when the time period t lies within a range of from time 0 to time tm. Further, the allowable temperature Td(t) is equal to the allowable temperature Td2 when the time period t lies within a range occurring after time tm. However, this is but one example, and the allowable temperature Td(t) may be switched between three or more values. Further, when the time period t lies within a range from time tm to time tx, the allowable temperature Td(t) may gradually change from the allowable temperature Td1 to the allowable temperature Td2.

In FIG. 3, the temperature T(t) changes due to the generation of heat caused by a driving current I(t) that changes over time. The determination unit 26, at time ty, determines whether the temperature T(t) has exceeded the temperature protection line (the allowable temperature Td(t)).

The allowable temperature (the temperature protection line) Td(t) is determined on the basis of a magnitude I of the electrical current supplied from the electric motor driving device 14 to the electric motor 12, and the time period t during which the electrical current is continuously supplied. Hereinafter, a specific method of calculating the allowable temperature Td(t) will be described.

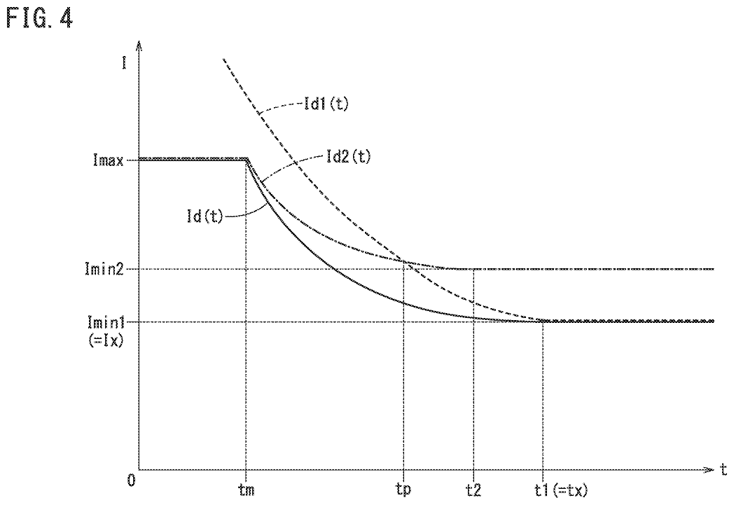

FIG. 4 is a diagram showing one example of a time-wise change in the electrical current. Specifically, FIG. 4 shows a relationship between (a magnitude of) the electrical current I supplied from the electric motor driving device 14 to the electric motor 12, and the time period t during which the current is continuously supplied.

A limit current Id1(t) represents a limit of the electrical current I defined from the temperature limit of the electric motor 12. A limit current Id2(t) represents a limit of the electrical current I defined from the temperature limit of the electric motor driving device 14. Moreover, it should be noted that the limit current Id1(t) at time t signifies an electrical current value at which the electric motor 12 arrives at a thermal limit, in the case that the limit current Id1(t) continues to flow for the time period t from a starting time thereof. Further, the limit current Id2(t) at time t (>tm) signifies an electrical current value at which the electric motor driving device 14 arrives at a thermal limit, in the case that the limit current Id2(t) continues to flow for the time period t from a starting time thereof. Either one of the limit current Id1(t) and the limit current Id2(t) is relatively large at time 0 (at the beginning of starting of the electric motor 12 and the electric motor driving device 14), but gradually decreases as the time period t elapses. Ultimately, the limit current Id1(t) and the limit current Id2(t) each approach toward a constant value. The limit current Id1(t) approaches toward a minimum current Imin1 of a constant value. The limit current Id2(t) approaches toward a minimum current Imin2 of a constant value. The minimum current Imin1 is an electrical current value that does not exceed the thermal limit of the electric motor 12, even if the electrical current continues to flow to the electric motor 12. The minimum current Imin2 is an electrical current value that does not exceed the thermal limit of the electric motor driving device 14, even if the electrical current continues to flow to the electric motor driving device 14.

The electric motor 12 and the electric motor driving device 14 are different in terms of their constituent components and the like, and as a result, exhibit different heat resistance (temperature resistance) characteristics. Therefore, there is a difference between the limit current Id1(t) and the limit current Id2(t). The limit current Id1(t) decreases from time 0, and becomes a constant value (the minimum current Imin1: a second limit current) after time t1. The limit current Id2(t) is of a constant value (a maximum current Imax: a first limit current) from time 0 to time tm. The time period between time 0 and time tm is a time period, for example, a period of several seconds, during which the first limit current is supplied. Thereafter, the limit current Id2(t) gradually decreases, and becomes a constant value (the minimum current Imin2: a third limit current) after time t2. Moreover, it should be noted that the period from time 0 to time tm corresponds to a predetermined time period from when the electric motor 12 starts to operate until the electric motor 12 reaches a certain operating state. The limit current Id2(t) need not necessarily be constant, and may undergo a change between time 0 and time tm.

The maximum current Imax and the time period tm are primarily determined from the characteristics of a switching element that constitutes the electric motor driving device 14. The maximum current Imax, for example, is a rated value, and is defined from an upper limit of the electrical current that the electric motor driving device 14 is capable of outputting. The time period tm, for example, is a rated value, and is defined from the time period during which the electric motor driving device 14 is capable of enabling the maximum current Imax to continuously flow. The minimum current Imin1 is defined as an electrical current value at which the temperature limit of the electric motor 12 is not exceeded, even if an electrical current of such a magnitude continues to flow from the electric motor driving device 14 to the electric motor 12. The minimum current Imin2 is defined as an electrical current value at which the temperature limit of the electric motor driving device 14 is not exceeded, even if an electrical current of such a magnitude continues to flow from the electric motor driving device 14 to the electric motor 12.

The limit current Id(t) corresponds to a smaller one from among the limit current Id1(t) and the limit current Id2(t). In this instance, in order to facilitate viewing thereof, the limit current Id(t) is shifted slightly below the limit current Id1(t) and the limit current Id2(t). Until time tm, the limit current Id(t) is equal to the substantially constant maximum current Imax, and further, after time tx (=t1), is equal to a substantially constant electrical current Ix (in this instance Ix=Imin1). Between time tm and time tx, the limit current Id(t) gradually decreases from the maximum current Imax to the electrical current Ix.

In this instance, between time tm and time t1, the limit current Id(t) is smaller than the limit current Id1(t) and the limit current Id2(t). However, the limit current Id(t) may substantially coincide with a smaller one from among the limit current Id1(t) and the limit current Id2(t). For example, prior to time tp, the limit current Id(t) may coincide with the limit current Id2(t), and after time tp, may coincide with the limit current Id1(t). By setting the limit current Id(t) to a smaller one from among the limit current Id1(t) and the limit current Id2(t), both the electric motor 12 and the electric motor driving device 14 can be protected. Moreover, it should be noted that, after time tm, the limit current Id(t) may be defined based on a function.

In the present example, the electrical current Ix is equal to the minimum current Imin1 of the electric motor 12. More specifically, the electrical current Ix is determined on the basis of a temperature limit (the limit current Id1(t)) of the electric motor 12. However, in general, the electrical current Ix is determined on the basis of a smaller one from among the temperature limit of the electric motor 12 and the electric motor driving device 14. Specifically, the electrical current Ix is determined on the basis of a smaller one from among the limit current Id1(t) and the limit current Id2(t). For example, the limit current Id(t) may be determined only from the limit current Id2(t) of the electric motor driving device 14.

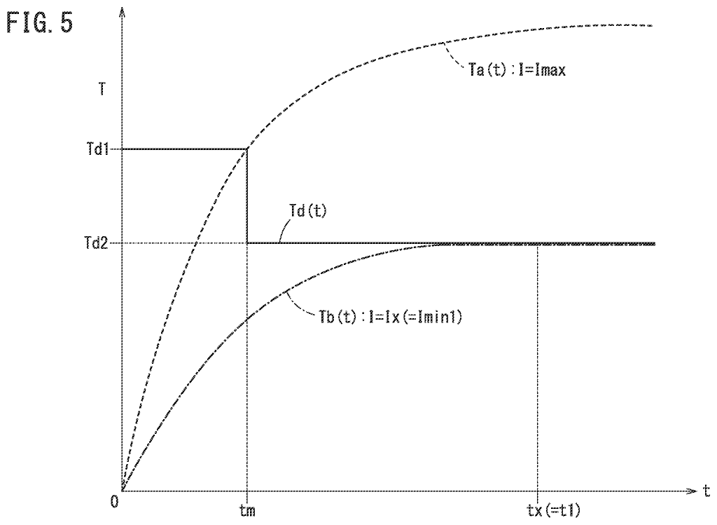

The allowable temperature Td(t) is defined based on the limit current Id(t). FIG. 5 is a diagram showing an example of the temperature protection line. As noted previously, at approximately time tm, the temperature protection line (the allowable temperature Td(t)) switches from the allowable temperature Td1 (a first temperature threshold value) to the allowable temperature Td2 (a second temperature threshold value). FIG. 5 collectively shows a temperature Ta(t) and a temperature Tb(t). The temperature Ta(t) is a temperature during a period when the driving current I is constant at the maximum current Imax. The temperature Tb(t) is a temperature during a period when the driving current I is constant at the electrical current Ix (=the minimum current Imin1).

The allowable temperature Td(t) is determined, for example, by substituting the limit current Id(t) for the current I in Equation (5), and thereby calculating the temperature T1(t). In this case, the allowable temperature Td1 (the first temperature threshold value) is defined based on the maximum current Imax (the first limit current) and the continuing time period tm (the time period during which the first limit current is supplied). The allowable temperature Td2 (the second temperature threshold value) is defined based on the electrical current Ix (the second limit current). More specifically, as shown in FIG. 5, the allowable temperature Td1 is defined based on a temperature Ta(tm) at the time tm for the case in which the maximum current Imax is made to flow. Further, the allowable temperature Td2 is defined based on a saturation value of a temperature Tb(t1) for a case in which the electrical current Ix is made to flow. In the case that a constant current Ix is made to flow, the temperature Tb(t) increases together with the passage of time, reaches the (saturation) temperature Tb(t1) at time t1, and thereafter, remains constant.

As noted previously, the temperature calculation unit 22 calculates, for example, the temperature T1(t) of the electric motor 12 as the temperature T(t) that represents the electric motor 12 and the electric motor driving device 14. More specifically, the temperature calculation unit 22 calculates the temperature T1(t) using Equation (5). On the other hand, the allowable temperature Td(t) (the allowable temperature Td1 and the allowable temperature Td2) also is calculated based on the temperature T1(t) of the electric motor 12. By making the calculation methods uniform in this manner, consistency between a comparison target (the temperature T(t)) and a reference (the allowable temperature Td(t)) can be achieved, and therefore comparison between the comparison target and the reference becomes easy to perform. Moreover, the temperature T(t) and the allowable temperature Td(t) may be calculated using the same calculation method, for example, using the temperature T2 of the electric motor driving device 14 (see Equation (7)).

Hereinafter, descriptions will be given of examples in which both of the electric motor 12 and the electric motor driving device 14 can be protected from temperature, by calculating the temperature (the temperature T1(t) or the temperature T2(t)) of only one of the electric motor 12 and the electric motor driving device 14. Moreover, in these examples, a magnitude relationship between the time constant τ1 and the time constant τ2 of the electric motor 12 and the electric motor driving device 14 need not be determined.

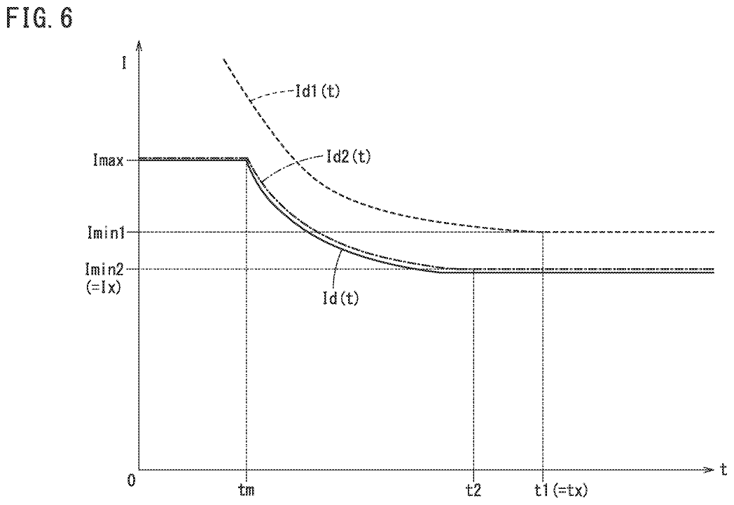

FIG. 6 is a diagram showing another Example 1 of a time-wise change in the electrical current. FIG. 6 is a diagram that corresponds with FIG. 4. However, unlike FIG. 4, in FIG. 6, the limit current Id1(t) of the electric motor 12 is always greater than the limit current Id2(t) of the electric motor driving device 14. Accordingly, the line of the limit current Id1(t) does not intersect the line of the limit current Id2(t). In this case, as shown in FIG. 6, the limit current Id(t) is less than or equal to the limit current Id2(t). In this instance, until time tm, the limit current Id(t) is equal to the maximum current Imax (the first limit current), and further, after time t2, is equal to the minimum current Imin2 (the third limit current). Between time tm and time t2, the limit current Id(t) gradually decreases from the maximum current Imax to the minimum current Imin2. In this case, prior to time tm, the allowable temperature Td(t) is equal to the allowable temperature Td1 (the first temperature threshold value), and after time tm, is equal to an allowable temperature Td3 (a third temperature threshold value). Moreover, since the allowable temperature Td(t) of Example 1 also includes the same tendency as the temperature protection line shown in FIG. 5, illustration of the allowable temperature Td(t) of Example 1 itself is omitted. More specifically, the allowable temperature Td(t) of Example 1 corresponds to a graph in which the allowable temperature Td2 and the minimum current Imin1 shown in FIG. 5 are replaced by the allowable temperature Td3 and the minimum current Imin2, respectively. As noted previously, the allowable temperature Td1 is defined based on the maximum current Imax and the time period tm. Further, the allowable temperature Td3 is defined based on the minimum current Imin2.

In such a case, by calculating the temperature T2(t) of the electric motor driving device 14 and comparing it with the allowable temperature Td(t), it becomes possible to protect not only the electric motor driving device 14 but also the electric motor 12. More specifically, in the case that the thermal limit (the limit current Id1(t)) of the electric motor 12 is sufficiently larger than the thermal limit (the limit current Id2(t)) of the electric motor driving device 14, the thermal limit of the electric motor 12 need not be considered to present a problem.

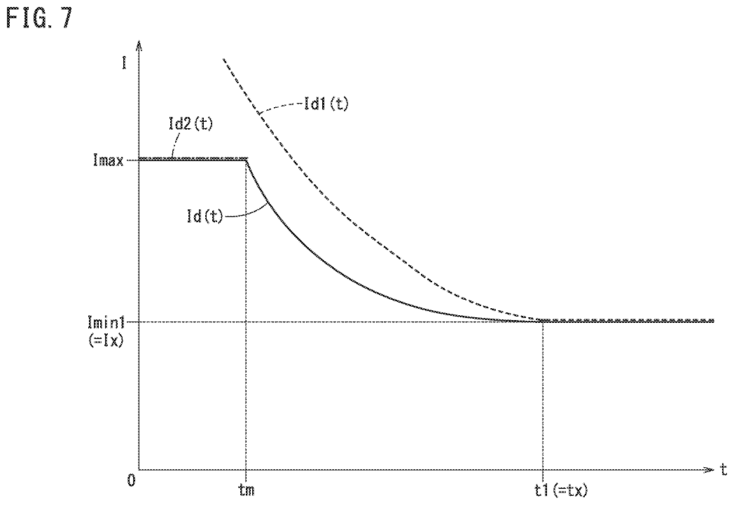

FIG. 7 is a diagram showing another Example 2 of a time-wise change in the electrical current. FIG. 7 is a diagram that corresponds with FIG. 4. However, in FIG. 7, after time tm, the limit current Id2(t) of the electric motor driving device 14 is omitted, as it can be substantially ignored. In general, in the case that the electric motor 12 is driven, although a large electrical current is required at the time when driving thereof is initiated, a relatively small current may be used when the driving thereof becomes stable. Therefore, after time tm, it is possible to substantially ignore the limit current Id2(t). In this case, as shown in FIG. 7, after time t1, the limit current Id(t) is the minimum current Imin1 of a constant value, and from time tm to time t1, the limit current Id(t) can gradually approach toward the minimum current Imin1 from the maximum current Imax. Further, similar to what is shown in FIG. 5, prior to time tm, the allowable temperature Td(t) is equal to the allowable temperature Td1 (the first temperature threshold value), and after time tm, is equal to the allowable temperature Td2 (the second temperature threshold value). As noted previously, the allowable temperature Td1 is defined based on the maximum current Imax (the first limit current) and the time period tm (the time period during which the first limit current is supplied). Further, the allowable temperature Td2 is defined based on the minimum current Imin1 (the second limit current).

In such a case, by calculating the temperature T1(t) of the electric motor 12 and comparing it with the allowable temperature Td(t), it becomes possible to protect not only the electric motor 12, but also the electric motor driving device 14. More specifically, in Example 2, in comparison with the limit current Id2(t) that defines the thermal limit of the electric motor driving device 14, the electrical current I after time tm is considered to be so small as to not result in a problem. Therefore, if the temperature T1(t) of the electric motor 12 is less than or equal to the allowable temperature Td(t), the electric motor driving device 14 will not exceed the thermal limit.

### (Operation Procedure of the Electric Motor Control System 10)

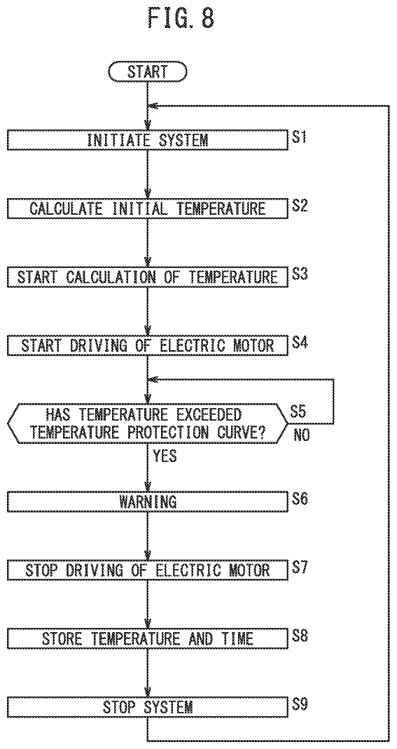

FIG. 8 is a diagram showing an example of an operation procedure of the electric motor control system 10 according to the embodiment. The electric motor control system 10 is started from a stopped state (step S1). Specifically, in step S1, the power source of the electric motor driving device 14 and the control device 16 is placed in an ON state. Hereinafter, in order to facilitate understanding, a procedure for calculating the temperature T1(t) of the electric motor 12 will be described. A description of a procedure for calculating the temperature T2(t) of the electric motor driving device 14 is omitted. However, the temperature T2(t) can be calculated using a similar procedure as when calculating the temperature T1(t).

The initial temperature calculation unit 24 of the control device 16 calculates the initial temperature T(0) (the temperature T at the time when the electric motor control system 10 is started) (step S2). In this calculation, information concerning the temperature Toff and the time when the electric motor control system 10 is stopped (in particular, the time at which the power source of the electric motor driving device 14 is turned OFF), which is stored in the storage unit 24a, is used. The initial temperature calculation unit 24 calculates the initial temperature T(0), for example, by substituting the temperature Toff and the elapsed time period te into Equation (9).

Thereafter, the temperature calculation unit 22 starts the calculation of the temperature T1(t) (step S3). For example, using Equation (5), the temperature calculation unit 22 calculates the temperature T1(t) from the initial temperature T1(0) and the electrical current value I.

By controlling the electric motor driving device 14, the control device 16 (the control unit 28) causes the driving of the electric motor 12 to start (step S4). As a result, generation of heat from the heat generating unit 12a and the heat generating unit 20a is started. Thereafter, the temperature calculation unit 22 repeats the calculation of the temperature T1(t).

Based on the temperature T1(t) and the table 26a, the determination unit 26 determines whether or not the temperature T1(t) has exceeded the temperature protection line (the allowable temperature Td(t)) (step S5). In the case that the result of such a determination is “YES”, the warning unit 30 issues a warning (step S6). Further, by controlling the electric motor driving device 14, the control unit 28 causes the driving of the electric motor 12 to stop (step S7). If the determination in step S5 is “NO”, the temperature calculation unit 22 repeats the calculation of the temperature T1(t) and the determination by the determination unit 26. The temperature protection line in FIG. 8 is a curved shape (a temperature protection curve).

After step S7, the initial temperature calculation unit 24 causes the temperature T at the time when the power source is turned OFF as well as the time when the power source is turned OFF to be stored in the storage unit 24a (step S8). Thereafter, the electric motor control system 10 is stopped (step S9).

The storage unit 24a stores the temperature Toff at the time when the power source is turned OFF and also stores the time when the power source is turned OFF. The off-time temperature Toff and the off-time time are used to calculate the initial temperature T(0) in step S2 at the time when the electric motor control system 10 is started for the next time.

In the foregoing manner, the electric motor control system 10 calculates the temperature T(t) of the electric motor 12 or the electric motor driving device 14 based on the driving current of the electric motor 12. Further, the electric motor control system 10 determines whether or not the temperature T(t) has exceeded the temperature protection line (the allowable temperature Td(t)). Consequently, based on the temperature T(t), it is possible to protect the electric motor 12 and the electric motor driving device 14.

Further, even if the electric motor 12 and the electric motor driving device 14 are started from a stopped state, the electric motor control system 10 is capable of determining whether or not the temperature T(t) has exceeded the temperature protection line. Based on information of the temperature Toff of the electric motor 12 or the electric motor driving device 14 at a previous time of being stopped, the initial temperature at a subsequent time of being started is calculated. More specifically, the temperature T(t) can be calculated, even in the case that the electric motor control system 10 is operated intermittently. Moreover, not only the electric motor 12 and the electric motor driving device 14, but also the control device 16 can similarly determine whether or not the temperature T(t) has exceeded the temperature protection line, even in the case of being started from a stopped state.

### Modified Embodiments

The present invention is not limited to the embodiment described above, and various configurations can be adopted therein without departing from the essence and gist of the present invention.

Within the control device 16 of the above-described embodiment, the temperature calculation unit 22, the initial temperature calculation unit 24, the determination unit 26, and the warning unit 30 can be considered as being a temperature protection device that protects from temperature the electric motor 12 and the electric motor driving device 14 that causes the electric motor 12 to be driven. More specifically, the control device 16 includes the temperature protection device. In contrast to this feature, a temperature protection device may be constituted by the temperature calculation unit 22, the initial temperature calculation unit 24, the determination unit 26, and the warning unit 30, separate from the control device 16 itself.

### Inventions that can be Obtained from the Embodiments

The inventions that are capable of being grasped from the above-described embodiments will be described below.
(1) The temperature protection device (the control device 16) is equipped with the storage unit (the table 26a) that, in order to protect from temperature the electric motor (12) and the electric motor driving device (14) that drives the electric motor, stores the temperature protection line (Td(t)) defined on the basis of the time period during which the electrical current is continuously supplied to the electric motor from the electric motor driving device, and the allowable temperature of the electric motor and the electric motor driving device, the electrical current acquisition unit (the temperature calculation unit 22) that acquires the electrical current value of the electrical current supplied to the electric motor from the electric motor driving device, the temperature calculation unit (22) that calculates the temperature (T(t)) of the electric motor or the electric motor driving device based on the electrical current value that was acquired, the determination unit (26) that determines whether or not the temperature has exceeded the temperature protection line, and the notification unit (the warning unit 30) that, in the case that the determination unit has determined that the temperature has exceeded the temperature protection line, issues a notification to that effect. In accordance with such features, by calculating the temperature on the basis of the electrical current value, the electric motor and the electric motor driving device can be protected from temperature.
(2) The temperature protection line is determined on the basis of the magnitude of the electrical current supplied from the electric motor driving device to the electric motor, and the time period during which the electrical current is continuously supplied. In accordance with this feature, by the temperature protection line being determined on the basis of the magnitude of the electrical current supplied from the electric motor driving device to the electric motor, and the time period during which the electrical current is continuously supplied, it is possible to protect the electric motor and the electric motor driving device from temperature.
(3) The temperature protection line is determined on the basis of the limit current (Id(t)) and a time period during which the limit current is supplied, the limit current corresponding to a smaller one from among the limit (the limit current Id1(t)) of the electrical current defined from the temperature limit of the electric motor, and the limit (the limit current Id2(t)) of the electrical current defined from the temperature limit of the electric motor driving device. In accordance with this feature, by determining the temperature protection line while taking into consideration a smaller temperature limit of the electric motor and the electric motor driving device, it is possible to protect the electric motor and the electric motor driving device from temperature.
(4) The temperature protection line includes a first temperature threshold value (Td1) determined on the basis of: the first limit current magnitude (Imax) defined from the temperature limit of the electric motor driving device within the predetermined time period (a time period corresponding to from time 0 to time tm) from the start of driving of the electric motor; and the time period (tm) during which the first limit current is supplied, the determination unit determines whether or not the temperature has exceeded the first temperature threshold value within the predetermined time period, and in the case that the determination unit determines that the temperature has exceeded the first temperature threshold value within the predetermined time period, the notification unit issues a notification to that effect. In accordance with such features, it is possible to effectively protect the electric motor and the electric motor driving device within the predetermined time period from the start of driving the electric motor.
(5) The temperature protection line includes the second temperature threshold value (Td2) determined on the basis of the second limit current (Imin1) defined from the temperature limit of the electric motor after the predetermined time period (tm) from the start of driving of the electric motor, the temperature calculation unit calculates the temperature of the electric motor, the determination unit determines whether or not the temperature has exceeded the second temperature threshold value after the predetermined time period, and in the case that the determination unit determines that the temperature has exceeded the second temperature threshold value after the predetermined time period, the notification unit issues a notification to that effect. In accordance with such features, within the predetermined time period after the start of driving of the electric motor, by comparing the temperature of the electric motor with the second temperature threshold value, the electric motor and the electric motor driving device can be protected from temperature.
(6) The temperature protection line includes the third temperature threshold value (Td3) determined on the basis of the third limit current (Imin2) defined from the temperature limit of the electric motor driving device after the predetermined time period from the start of driving of the electric motor, the temperature calculation unit calculates the temperature of the electric motor driving circuit, the determination unit determines whether or not the temperature has exceeded the third temperature threshold value after the predetermined time period, and in the case that the determination unit determines that the temperature has exceeded the third temperature threshold value after the predetermined time period, the notification unit issues a notification to that effect. In accordance with such features, within the predetermined time period after the start of driving of the electric motor, by comparing the temperature of the electric motor driving device with the third temperature threshold value, the electric motor and the electric motor driving device can be protected from temperature.
(7) The temperature calculation unit calculates the generated amount of heat (Ph) from the electrical current value (I), and calculates the temperature (T(t)) of the electric motor or the electric motor driving device on the basis of the amount of heat, and the time constant (t) determined from the heat capacity (Ch) and the heat resistance (Rh) of the electric motor or the electric motor driving device. In accordance with this feature, it becomes possible to calculate the temperature while taking into consideration the heat radiation from the electric motor or the electric motor driving device.
(8) There is further provided the initial temperature calculation unit (24) that calculates the initial temperature of the electric motor or the electric motor driving device at the time when the electrical power source of the electric motor driving device is turned ON, on the basis of the elapsed time period from when the power source of the electric motor driving device is turned OFF until the power source of the electric motor driving device is turned ON, and the temperature at the off-time calculated by the temperature calculation unit at the time when the power source of the electric motor driving device is turned OFF, wherein the temperature calculation unit calculates the temperature based on the initial temperature and the electrical current value. In accordance with such features, in the case that the electric motor and the electric motor driving device are not at a sufficiently low temperature, the temperature can be calculated in consideration of the initial temperature.
(9) The initial temperature calculation unit calculates the initial temperature from the elapsed time period, the temperature at the off-time, and the time constant determined from the heat capacity and the heat resistance of the electric motor or the electric motor driving device. In accordance with this feature, it becomes possible to calculate the initial temperature while taking into consideration the heat radiation from the electric motor or the electric motor driving device.
(10) There is further provided the drive stop unit (the control unit 28) that stops driving of the electric motor, in the case that the determination unit has determined that the temperature has exceeded the temperature protection line.

Consequently, in the case that the temperature has exceeded the temperature protection line, driving of the electric motor can be stopped, and thereby the electric motor and the electric motor driving device can be protected from temperature.
(11) The control device (16) includes the temperature protection device, and controls the electric motor driving device. In accordance with this feature, it becomes possible to control the electric motor driving device, and to protect the electric motor and the electric motor driving device from temperature.

1. A temperature protection device, comprising:
a storage unit that, in order to protect from temperature an electric motor and an electric motor driving device configured to drive the electric motor, is configured to store a temperature protection line defined on the basis of a time period during which electrical current is continuously supplied to the electric motor from the electric motor driving device, and an allowable temperature of the electric motor and the electric motor driving device;
an electrical current acquisition unit configured to acquire an electrical current value of the electrical current supplied to the electric motor from the electric motor driving device;
a temperature calculation unit configured to calculate a temperature of the electric motor or the electric motor driving device based on the electrical current value that was acquired;
a determination unit configured to determine whether or not the temperature has exceeded the temperature protection line; and
a notification unit that, in a case that the determination unit has determined that the temperature has exceeded the temperature protection line, is configured to issue a notification to that effect.

2. The temperature protection device according to claim 1, wherein the temperature protection line is determined on the basis of a magnitude of an electrical current supplied from the electric motor driving device to the electric motor, and a time period during which the electrical current is continuously supplied.

3. The temperature protection device according to claim 2, wherein the temperature protection line is determined on the basis of a limit current and a time period during which the limit current is supplied, the limit current corresponding to a smaller one from among a limit of the electrical current defined from a temperature limit of the electric motor, and a limit of the electrical current defined from a temperature limit of the electric motor driving device.

4. The temperature protection device according to claim 2, wherein:
the temperature protection line includes a first temperature threshold value determined on the basis of: a first limit current magnitude defined from a temperature limit of the electric motor driving device within a predetermined time period from the start of driving of the electric motor; and a time period during which the first limit current is supplied;
the determination unit determines whether or not the temperature has exceeded the first temperature threshold value within the predetermined time period; and
in a case that the determination unit determines that the temperature has exceeded the first temperature threshold value within the predetermined time period, the notification unit issues a notification to that effect.

5. The temperature protection device according to claim 2, wherein:
the temperature protection line includes a second temperature threshold value determined on the basis of a second limit current defined from the temperature limit of the electric motor after a predetermined time period from the start of driving of the electric motor;
the temperature calculation unit calculates the temperature of the electric motor;
the determination unit determines whether or not the temperature has exceeded the second temperature threshold value after the predetermined time period; and
in a case that the determination unit determines that the temperature has exceeded the second temperature threshold value after the predetermined time period, the notification unit issues a notification to that effect.

6. The temperature protection device according to claim 2, wherein:
the temperature protection line includes a third temperature threshold value determined on the basis of a third limit current defined from the temperature limit of the electric motor driving device after a predetermined time period from the start of driving of the electric motor;
the temperature calculation unit calculates the temperature of the electric motor driving circuit;
the determination unit determines whether or not the temperature has exceeded the third temperature threshold value after the predetermined time period; and
in a case that the determination unit determines that the temperature has exceeded the third temperature threshold value after the predetermined time period, the notification unit issues a notification to that effect.

7. The temperature protection device according to claim 1, wherein the temperature calculation unit calculates a generated amount of heat from an electrical current value, and calculates a temperature of the electric motor or the electric motor driving device on the basis of the generated amount of heat, and a time constant determined from a heat capacity and a heat resistance of the electric motor or the electric motor driving device.

8. The temperature protection device according to claim 1, further comprising:
an initial temperature calculation unit configured to calculate an initial temperature of the electric motor or the electric motor driving device at a time when an electrical power source of the electric motor driving device is turned ON, on the basis of: an elapsed time period from when the power source of the electric motor driving device is turned OFF until the power source of the electric motor driving device is turned ON; and a temperature at an off-time calculated by the temperature calculation unit at a time when the electrical power source of the electric motor driving device is turned OFF;
wherein the temperature calculation unit calculates the temperature based on the initial temperature and the electrical current value.

9. The temperature protection device according to claim 8, wherein the initial temperature calculation unit calculates the initial temperature from the elapsed time period, the temperature at the off-time, and a time constant determined from a heat capacity and a heat resistance of the electric motor or the electric motor driving device.

10. The temperature protection device according to claim 1, further comprising a drive stop unit configured to stop driving of the electric motor, in a case that the determination unit has determined that the temperature has exceeded the temperature protection line.

11. A control device including the temperature protection device according to claim 10, and configured to control the electric motor driving device.
